(19) United States
(12) Patent Application Publication
(10) Pub. No.: US 2008/0198761 A1
(43) Pub. Date: Aug. 21, 2008

(54) DECENTRALIZED NETWORK ARCHITECTURE FOR TRAVEL RELATED SERVICES

(75) Inventors: Stanley Murawski, Redmond, WA (US); Michael Graber, Redmond, WA (US); Glen Zwart, Redmond, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/675,610

(22) Filed: Feb. 15, 2007

(51) Int. Cl. H04L 12/28

(52) U.S. Cl. 370/254

(57) ABSTRACT

A decentralized grid architecture is disclosed for a travel-related network. The system moves the functionality previously performed by a GDS down to the travel consumers' computing devices. The grid architecture may include travel consumers and travel service providers, as well as a grid manager for implementing the network. Cross-selling and value-add services are also provided to enhance the user experience and present the most attractive and economical options to the travel consumer.

### BACKGROUND

At present, travel and tourism is a 1.3 trillion dollar per year industry in the United States and estimated at about 6.5 trillion dollars worldwide. The travel industry includes travel service providers (TSP), a global distribution system (GDS), travel service brokers (TSB) and travel consumers (TC). A conventional network of these travel-related components is shown in FIG. 1.

Travel service providers broadly include all organizations that provide products or services related to travel. Examples of these providers include the following:
All commercial organizations that provide transport for a travel consumer from one point to another. Examples include airlines, car rental agencies, trains, ocean liners, limo services, bus services, taxis, etc.
All commercial organizations providing hospitality. This group includes hotels such as traditional hotels, cruise lines, bed and breakfasts, resorts, etc., as well as restaurants and other food services that provide food to the travel consumer.
Attractions, i.e., those commercial organizations that provide entertainment to the travel consumers, such as for example amusement parks, national parks, gaming events, museums, etc.
Retailers that sell retail-related products and services associated with travel. These include a wide variety of commercial organizations, such as for example a scuba gear shop providing scuba equipment to vacationers, a pharmaceutical company selling water purification tablets for third-world vacationers, and luggage vendors. A wide variety of other retailers would fall under this category.
Media organizations that provide literature relating to travel, including in book or web form.
   A wide variety of other travel service providers exist.

The global distribution system was originally set up by the airlines to track, aggregate and manage the massive amount of data associated with consumer travel. GDSs developed into centralized repositories for information including routes, schedules, fares, availability and promotions, across different travel sectors, and across different players within each travel sector. At present there are four major GDSs: Sabre®, Galileo®, Amadeus® and Worldspan®. At its core, a GDS runs primarily on IBM's Transaction Processing Facility (TPF), which is a highly specialized operating system originally implemented about 40 years ago as the Airline Control Program (ACP) and which is periodically upgraded.

A GDS receives travel routes, schedules, fares, availability and promotions from different travel service providers. The GDS then transmits this information through a wide area network to established travel service brokers. TSBs include travel agencies, such as traditional brick and mortar travel agencies and web-based travel portals (such as Expedia® and Travelocity®). Travel service brokers may also include traditional travel service providers. Namely, in addition to their core service, travel service providers may also act as a broker to sell ancillary travel services. As an example, many airlines have websites, where, after purchasing an airline ticket the airline offers the travel consumer the ability to purchase accommodations, car, and other travel-related services or products. A third group of travel service brokers are travel aggregators. These include tour companies which provide multiple travel-related services at one price.

As seen in FIG. 1, under the traditional GDS-based travel model, larger travel service providers 20 (airlines, car rental agencies and hotels) provide their travel-related information to a GDS 22, including route, schedule, fares, availability and promotions offered by the airlines/car rental agencies/hotels. The GDS mainframe includes databases and a variety of software application programs for storing, organizing and regularly updating this information so that it can provide travel itineraries compiled across the different travel service providers and optimized by schedule, fare, number of travel connections, or various other criteria set by a travel consumer 30. The travel service brokers, which may be a traditional travel agent 26 or a web-based travel portal 28, may pay a fee to the GDS 22 to access this information in response to inquiries from travel consumers 30. The GDS 22 may also include billing and accounting software application programs to keep track of purchases and financial transactions between the travel service providers, the GDS, the travel service brokers, and the travel consumers.

Prior to wide-spread adoption of the Internet, a GDS dealt mostly with traditional brick and mortar travel agents, who were then the primary means for travelers to book travel. However, with the rise of the Internet and the ease with which travelers can search for different travel options, the demands for information made on GDSs exploded. The amount of money each of the GDSs are now expending annually in license fees and to maintain and upgrade their mainframe hardware and software to keep pace with demand may be measured in hundreds of millions of dollars. These added costs are passed on to the travel service providers, the travel service brokers and the travel consumers.

Moreover, GDSs have traditionally focused almost exclusively on the larger travel service providers, such as airlines, car rentals and large accommodation providers, ignoring other smaller travel service providers. However, another consequence of the widespread acceptance of the Internet is that smaller travel service providers have flourished. As perspective on numbers of providers, there are approximately 500 airlines, thousands of hotels, and hundreds of thousands of small travel service providers. While each of these TSPs may be considered small, their aggregate revenue has been estimated to be ten times that of the airlines, rental agencies and hotels traditionally handled by GDSs. At present, search engines such as Google and MSN have capitalized on these smaller travel service providers by providing an effective advertising platform for these TSPs. As GDSs largely ignore or do not address this market sector, they are unable to share in the revenues they are generating.

At present, travelers are able to bypass the GDS and travel service brokers and contact the airlines directly. Moreover, some airlines (20a), do not use a GDS to publicize their services. These include for example Southwest Airlines® and America West Airlines®. In these scenarios, in order for travelers to learn of flight schedules, fares and to purchase tickets, travelers must contact the airlines directly. While travelers are able to pay slightly discounted fees by contacting airlines directly, because they do not have the overhead associated with the GDS and Brokers, there is no convenient method to optimize travel itineraries by schedule, fare, number of connections, etc. across the myriad of available travel service providers. The traveler must contact several airlines separately, learn which offer travel options to their destinations, and then select the best option. In this scenario, it is also possible that the traveler may never become aware of other travel service providers which offer attractive travel options to their desired destination.

Moreover, travel service providers often partner together on routes to offer joint discounted pricing or convenient schedules. While this information is presently made available to the GDS, there is no convenient way for a traveler to learn about this information when they are contacting airlines directly.

Furthermore, where a traveler directly contacts a travel service provider today, that contact is typically made between a web browser used by the traveler and a web server at the travel service provider. The use of a web browser to interact with a travel service provider is generally more limited in its capabilities, as compared for example to a smart client application program running on the traveler's computing device. Generally the interfaces provided by these web servers are intended for a human reader and are not suitable to be called (accessed) by a smart client computer program or any other.

### SUMMARY

The present technology, roughly described, relates to a decentralized grid architecture for a travel-related network. The system moves the functionality previously performed by a GDS down to the travel consumers' computing devices. The grid architecture may include travel consumers and travel service providers, as well as a grid manager for implementing the network. Cross-selling and value-add services are also provided to enhance the user experience and present the most attractive and economical options to the travel consumer.

Interaction between the grid architecture and travel consumers is controlled by a smart client application program downloaded or copied onto the travel consumers' computing devices. Using a graphical user interface, a travel consumer may specify the travel-related products and services of interest, as well as specifying any desired limiting criteria. The smart client may first contact the grid manager, which stores an index of the travel service providers that provide any products or services of interest to the travel consumer. In alternative embodiments, the smart client might use internet search capabilities to find products or services of interest to the travel consumer. The smart client may then contact the travel service providers with products or services of interest and retrieve those products and/or services. The results may be filtered and/or sorted as directed by the travel consumer via the user interface or according to pre-established personal preferences.

In addition to providing the search results, the smart client may communicate with various value-add services also forming part of the grid architecture. Such value-add services may include the ability to store a copy of purchased itineraries on remote servers, the ability to receive ad-word and advertisements tailored to the specific interests of the travel consumer and the ability to present the travel consumer with various joint pricing options and discounts to further reduce the cost or increase the convenience of planned travel.

The present system provides several advantages not found in conventional centralized GDS-based systems. First, the amount of infrastructure required to operate the grid architecture is greatly reduced. Mainframes costing hundreds of millions of dollars each year may be eliminated and the cost saving passed on to the various participants in the grid architecture. Moreover, the grid architecture of the present system makes the products and services of smaller travel service providers much more readily accessible to travel consumers. Further still, the search for products and services is not performed using a web-browser, which presents results in human-readable form from which a human makes travel selections. Instead, the client application program 122 is able to provide a computerized search for, and selection of, applicable products and services. This type of interface is quicker and more powerful that a web-browser search and able to simultaneously search for information from multiple providers.

### BRIEF DESCRIPTION OF THE DRAWINGS

FIG. 1 is a block diagram of a conventional travel-related architecture centralized around a global distribution system.

FIG. 2 is a block diagram of a decentralized grid architecture according to an embodiment of the present system.

FIG. 3 is a block diagram of a smart client according to an embodiment of the present system.

FIG. 4 is a block diagram of a grid manager according to an embodiment of the present system.

FIG. 5 is a block diagram of a travel content hub according to an embodiment of the present system.

FIG. 6 is a flowchart of a sample operation of a smart client according to an embodiment of the present system.

FIG. 7 is a representation of a sample graphical user interface which may be presented to a travel consumer by a smart client according to an embodiment of the present system.

FIG. 8 is a block diagram of a sample computing environment on which a smart client according to embodiments of the present system may be executed.

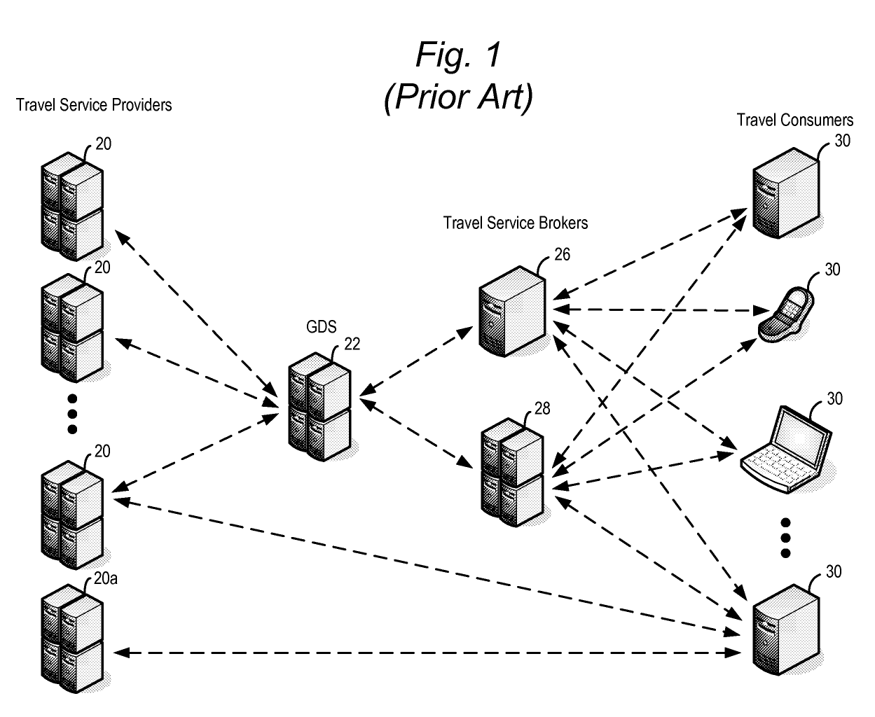

### DETAILED DESCRIPTION

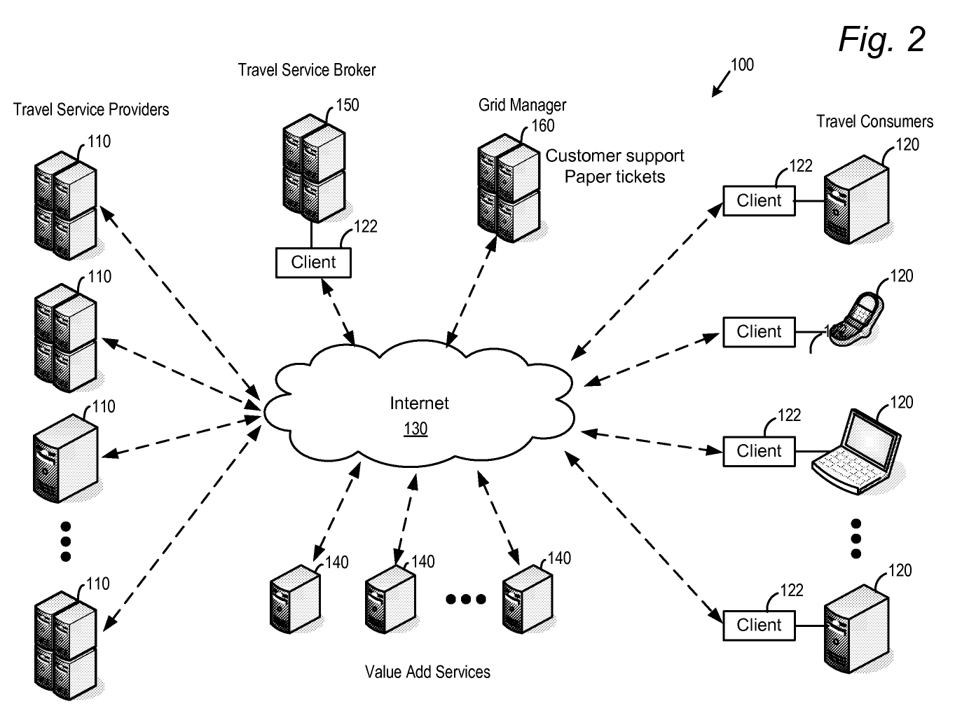

The present system will now be described with reference to FIGS. 2-8, which in general relate to a decentralized grid architecture for a travel-related network. As explained hereinafter, the architecture in general includes a smart client application program running on the computing devices of travel consumers. These smart clients communicate directly with a wide variety of travel service providers and value-add service providers using standard TCP/IP protocols to allow consumers to efficiently search and book travel itineraries, as well as receive cross-sale and value-add opportunities related to their travel plans. In the present system, the functionality previously performed by a centralized GDS and travel service brokers is moved to the personal computing devices of the travel consumers and the TSP's travel content hub. Accordingly, the GDS and travel service brokers are no longer required, and travel services may be bought and sold without the large overhead cost and complexity added by a GDS and travel service brokers.

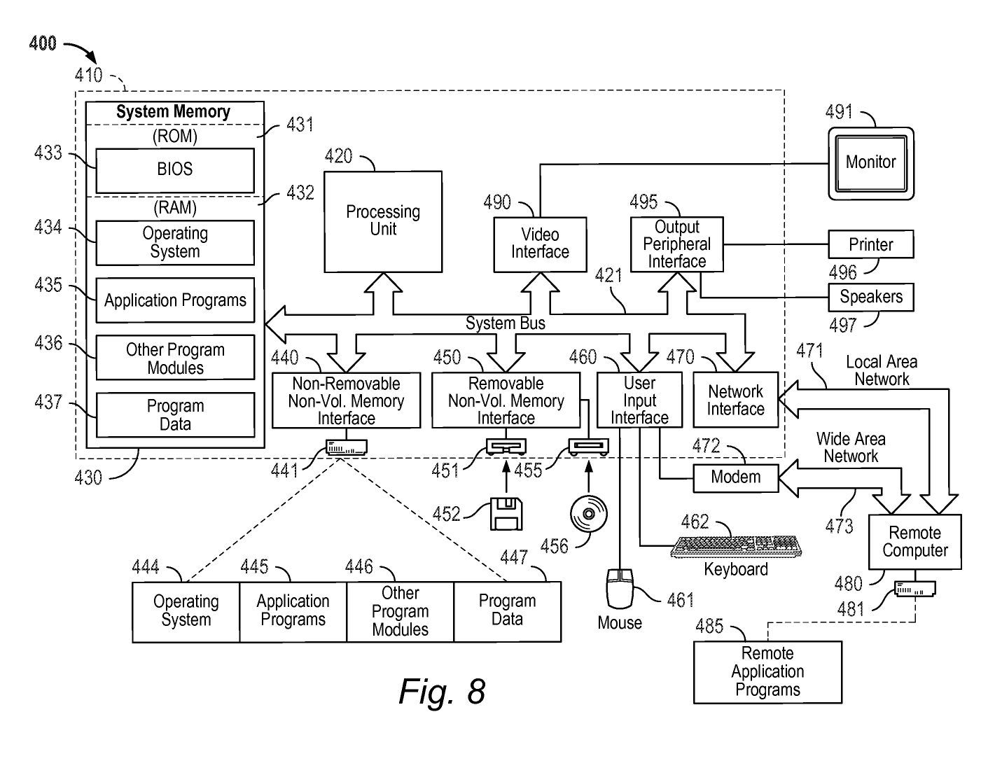

The smart client may be run on a wide variety of computing devices including for example desktop computers, laptops, handheld computers, personal digital assistants (PDAs), cellular telephones, multiprocessor systems, microprocessor-based systems, programmable consumer electronics, mini computers, and/or other such computing system environments. Details relating to one such computing system environment are explained hereinafter with respect to FIG. 8.

FIG. 2 shows a block diagram of networked components, referred to herein as grid architecture 100, according to an embodiment of the present system. The grid architecture 100 includes a plurality of travel service providers, each represented by a computing device referred to herein as a travel content hub 110. Travel content hub 110 may be a bank of one or more servers, but it may be a desktop, laptop or other computing device in further embodiments. The grid architecture 100 further includes a plurality of travel consumers, each represented by a computing device 120. The travel content hubs 110 and the computing devices 120 are capable of communicating with each other using standard Internet protocols over the Internet 130. It is understood that one or more of the travel content hubs 110 and computing devices 120 may be connected by LANs, WANs and other networks in the alternative embodiments.

Grid architecture 100 may further include a number of value-add service providers 140, a plurality of travel service brokers 150 and a grid manager, or network manager, 160. Each of these participants in the grid architecture is explained hereinafter. It is understood that one or more of the value-add service providers 140, travel service brokers 150 and/or grid manager 160 may be omitted in embodiments of the present system.

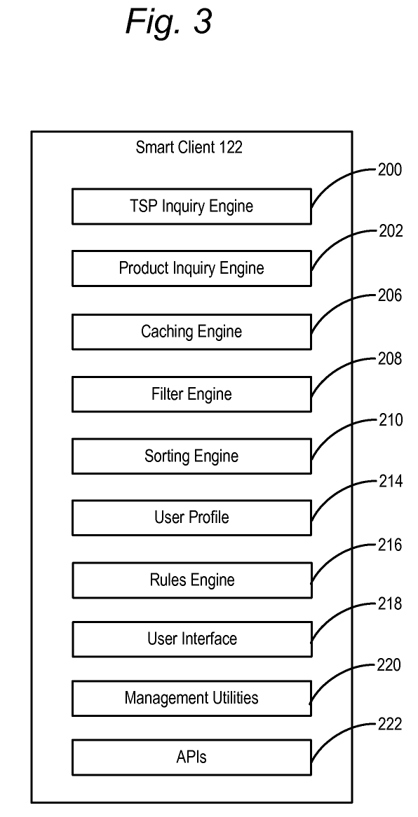

As indicated above, each travel consumer computing device 120 includes a smart client application program 122 stored in memory of the computing device 120. FIG. 3 is a block diagram of the software components within client 122. Each client 122 may include a TSP inquiry engine 200 for communicating with the grid manager to identify the providers of specific travel-related services. In particular, when a travel consumer performs a search of travel-related services, client 122 does not blast out the search to all travel service providers to see which of those provide the requested service (although it may be so in alternative embodiments). Instead, in embodiments, grid manager 160 maintains a database or product index 230 storing a list of products and services provided by the travel service providers within the grid. TSP inquiry engine 200 is provided to search product index 230 to provide the identity of travel service providers that fulfill the user's request for information.

As explained hereinafter, in an alternative embodiment, the grid manager 160 may be omitted. In such embodiments, TSP inquiry engine 200 may be replaced by a more traditional web search engine that may be used to find and cache travel service providers of certain products and services. This web-search may be performed at the travel consumer's request, or invisibly to the travel consumer.

Smart client 122 further includes a product inquiry engine or web crawler 202. As is known in the art, inquiry engine 202 is capable of crawling the travel service providers, identified by the grid manager, for all the products and services matching the search criteria. As will be explained hereinafter, legacy travel service providers may include an adapter 256 allowing the inquiry engine 202 to search the legacy TSPs and identify products and services therefrom. As is known in the art, inquiry engine 202 may return all results that meet the search criteria, or the inquiry engine 202 may search by particular criteria, such as for example for ski resorts in California, the lowest price plane fare, travel books for Spain, etc.

Cache engine 206 is provided to cache the results returned by TSP inquiry engine 200 and/or product inquiry engine 202. Cache engine 206 may reduce time and bandwidth usage by caching previously obtained results. Thus, where a user performs a new search, or such search is performed on behalf of the user, using the same or similar search criteria as was used before, the cache engine can return the cached results.

Smart client 122 may further include a filter engine 208 and a sorting engine 210 for filtering and sorting the products or services returned by the web search. In particular, a user may specify criteria via a user interface as explained hereinafter by which the search results are to be filtered. For example, a user may specify a preference for nonstop flights or hotel accommodations with only queen beds. In embodiments, the travel service provider may return all possibly relevant products and services, whereupon the returned products and services may be filtered by the filter engine 208. However, in alternative embodiments the filtering process may occur at the travel service provider. In other alternative embodiments, the filtering process may occur at a computer that is an intermediary between the smart client and the travel service provider. Sorting engine 210 is provided to sort the return results in an order specified by the user via the user interface. For example, the sorting filter may be used to sort the results by price, schedule, hotel class, etc.

User profile 214 is a database storing the user's profile, favorites, preferences, etc. It is understood that user profile 214 may be stored within the travel consumer computing device 120 separate and apart from smart client 122.

Rules engine 216 is provided to enforce any rules and restrictions placed on the user's travel-related search results. In embodiments, there may be a variety of categories of rules implemented by the rules engine 216. Individual travel consumers may specify rules, such as for example, a user may specify in a user profile 214 that they are only interested in economy rental cars, airline aisle seats, and no restaurants of a certain type. Additionally, a business may have corporate travel rules, such as for example no first class travel.

A further category of rules and restrictions which may be implemented by the client application program 122 are logistics rules. For example, logistics rules may include information such as minimum travel time required between gates, terminals or airports. This information may be sent to the client and stored from a variety of sources, including travel service providers, airports and other travel information repositories. A still further category of rules which may be implemented by the client application program are those relating to joint fares and promotions offered by two or more travel service providers acting in tandem. As explained hereinafter, a value-add service may be a server which receives joint fares and promotions from travel service providers, and then provides this information to travel consumers upon a query from a travel consumer. However, in embodiments operating without value-added services, joint fares may be sent to the client and stored in a variety of ways. For example, when the joint fair is established, it may be pushed to some or all travel consumers having client application 122.

A wide variety of other rules and restrictions may be specified by the user in the user profile or search query, and enforced by rules engine 216. These rules may be applied by the rules engine upon return of the results. Alternatively, the rules may be sent with the request for information and applied at the travel service providers.

Smart client 122 may further implement a user interface 218 and management utilities 220. User interface 218 is explained in greater detail hereinafter, but is provided to allow user interaction with smart client 122 and the travel service providers, grid manager and other components of the grid architecture 100. Management utilities 218 are provided to allow a user to customize the user interface as well as other aspects of smart client 122 to enhance the user experience in receiving travel-related services according to the present system.

Smart client 122 may further include one or more application programming interfaces (APIs) 222 for communication between smart client 122 and the host computing device 120. In particular, as indicated above, smart client 122 may be used on a variety of computing devices, including desktops, laptops, cellular telephones and PDAs. APIs 222 allow communication between smart client 122 and any proprietary applications on the host computing devices 120. In further embodiments of the present system, it is understood that the functionality of the smart client 122 may be implemented across more than one device, e.g., a smart phone and a desktop computer that work together to accomplish the functionality of the smart client 122.

It is understood that smart client 122 may include additional and/or alternative software components than those described above. In embodiments, smart client 122 may include software performing the functionality of a wide variety of other features currently implemented in conventional GDSs. This additional functionality includes but is not limited to the following:
Bargain fare searching—the ability to, find, sort and display a large number of diverse, lower-priced itineraries for available travel options.
Last minute fare searching—airlines frequently offer low fare for imminent travel dates.
Consolidator fare searching—access to fares offered by consolidators.
Manage your reserved itineraries—the ability to make changes to existing itineraries, including the ability to change reserved travel, and apply for refunds or exchanges where applicable.
Email confirmation—the ability to send an email confirmation of an itinerary, or add an itinerary to a computer calendar application program.
International travel—provide information unique to international travel, such as for example information as to whether visas are necessary for travel to a given country, any current vaccines which are required or recommended prior to travel to a country, current exchange rates, time differences, and other information.
   Other functionality for client application program 122 is contemplated.

While smart client 122 has been described above as being resident in the travel consumer computing device 120, it is understood that smart client 122, or portions of smart client 122, may be utilized by other participants in grid architecture 100. For example, in embodiments, travel service brokers 150 may use smart client 122, or incorporate smart client 122, or portions of smart client 122, into their own proprietary platform. Thus, a travel service broker 150, such as a traditional travel agent or web-based travel portal, may provide travel-related services to travel consumers who are not part of the grid architecture 100. Travel service brokers perform this same service today, but they perform this service by interacting with traditional GDS. In accordance with the present system, travel service brokers 150 may provide the same service without having to use a GDS.

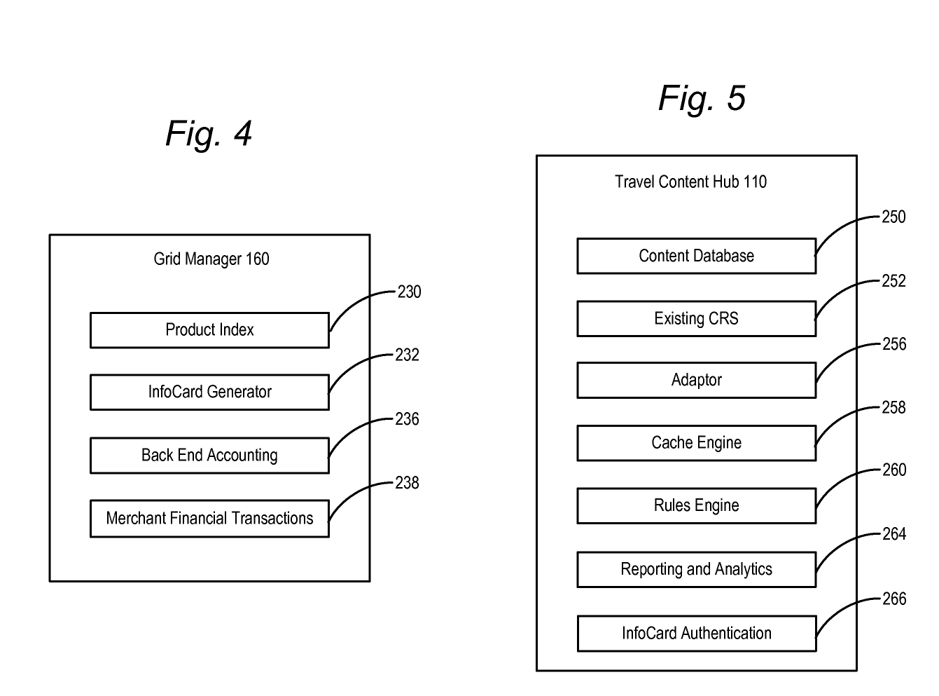

Referring now to FIG. 4, there is shown a block diagram of grid manager 160 according to the present system. In embodiments the grid manager implements the grid architecture by signing up travel service providers that wish to participate. The grid manager may also enable travel consumers to receive the smart client application program software, either by forwarding the smart client software to them, giving them access to download the smart client software, or working with or authorizing a third party provider that in turn provides traveling consumers with access to the smart client software.

The grid manager may be a corporate entity, enterprise service provider, financial institution or other organization, and may be travel service related or not. In embodiments, the grid manager 160 may be a company currently running a GDS or web-based travel agency. Thus, for example, Sabre® or Expedia® may host a grid architecture 100 whereupon travel service providers and travel consumers may subscribe to the grid architecture to link with each other through the grid.

As described above, grid manager 160 may maintain a database of products and services offered by travel service providers that belong to the grid and participate in the grid architecture 100. In particular, a travel service provider may contact grid manager 160 to join the grid architecture 100, potentially for a fee. Thereafter, that travel service provider may send the grid manager 160 a list of its products or services.

Grid manager 160 may further include an InfoCard generator 232 for issuing InfoCards in response to a request for an InfoCard by a travel consumer as is known in the art. As is known in the art, an InfoCard is a framework developed by Microsoft Corp. of Redmond, Wash., that securely stores digital identities of a person, and provides a unified interface for choosing the identity for a particular transaction, such as purchasing travel from a travel service provider website.

An accounting package 236 may also be part of grid manager 160 for keeping track of payments, invoices and accounting matters for travel service providers subscribing to the grid architecture 100 through the grid manager 160.

Grid manager 160 may further include a merchant financial services package 238 allowing the grid manager 160 to handle financial transactions on behalf of a travel service provider. In particular, some smaller travel service providers may not be set up to accept credit cards or other forms of electronic payment over the Internet. In such instances, the travel service provider may enlist the services of the grid manager 160 so that, upon completion of a transaction between a travel consumer and the travel service provider, payment for the services may be routed through the grid manager 160.

It is understood that the grid manager 160 may include additional and/or alternative software components in further embodiments of the present system.

Referring now to FIG. 5, there is shown a block diagram of a travel content hub 110 according to the embodiments of the present system. Travel content hub 110 may include a content database 250 and an existing computer reservations system 252 of conventional design. As discussed above, content travel hub 110 may further include an adapter 256. Adapter 256 uses known transformation protocols to allow smart client 122 to communicate with legacy databases within travel service providers that are inconsistent with the syntax of smart client 122.

Travel content hub 110 may further include a cache engine as is known in the art to store information previously requested from the content database 250. Thus, if a query is received in a travel service provider for the same information previously requested, it may be returned by cache engine 258 without having to perform a new search of the content database. Travel content hub 110 may further include a rules engine 260. As discussed above, smart client 122 includes a rules engine allowing individual and/or business rules to be included with a search for travel-related information. In the same manner, a travel service provider may have rules and restrictions relating to its services. Such rules may include, for example, travel restrictions relating to the number of carry-ons, blackout days for specified travel, and conditions under which an applicable discount may and may not be used, etc.

Travel content hub 110 may further include a reporting and analytics service for generating reports and analysis relating to products and/or services provided by the travel service provider. For example, an airline may run reports to determine how fare changes affect passenger volumes.

Travel content hub 110 may further include an InfoCard authentication module 266 for authenticating an InfoCard received from a travel consumer in a request for products or services. The authentication module 266 may authenticate the travel consumer, and once authenticated, deals and discounts may be offered to the travel consumer commensurate with his or her status as indicated by the InfoCard. For example, an InfoCard may keep track of award miles for traveling with a specific airline. When the InfoCard indicates miles above a specified threshold, the travel consumer may be offered various perks and/or discounts.

It is understood that the travel content hub 110 may include additional and/or alternative software components in further embodiments of the present system.

Another feature of the present system is the ability to include value-added services to travel consumers in grid architecture 100. For example, one of the value-add servers 140 may be an ad-word server. Ad-word advertising models used in conjunction with search engines are well known. In embodiments, travel service providers may send their key words to be stored on an ad-word server 140, as well as the advertisement to be displayed to a travel consumer where the travel consumer uses a specific ad-word in his or her search query. Accordingly, when a travel consumer performs a search-related query, the search may be forwarded to identified travel service providers, as well as to the ad-word server 140. In addition to receiving the list of products and services, the ad-word server returns the advertisement to be displayed to the travel consumer on the user interface as explained hereinafter.

As discussed above, another value-add service may be a trip repository server. When a travel consumer books a travel itinerary, that itinerary may be saved by smart client 122 to memory on the travel consumer computing device 120. However, a user may wish to access his or her itinerary when away from the computing device where the itinerary was stored. Accordingly, a travel consumer may additionally have the itinerary stored on a trip repository server 140. In that way, the user may access his or her itinerary from any network-connected computing device.

Another value-add service may be a joint pricing service where two or more travel service providers team up to provide a discount if a travel consumer avails him or herself of the combined services of the participating travel service providers. The travel consumer may not be able to identify the availability of this discount from contacting the respective travel service providers directly (as discussed above, this information may be pushed to the travel consumer in embodiments). However, upon a travel consumer specifying a search, the smart client 122 may additionally send that query to joint pricing server 140 to see if the query relates to any joint pricing bargains. If so, that information is passed back to smart client 122.

It is understood that a variety of other value-added services may be included as part of the present system in further embodiments of the present system. In a further embodiment, video conferencing may be supported for two or more travel consumers to communicate with each other during the process of looking for and booking products and services from travel service providers.

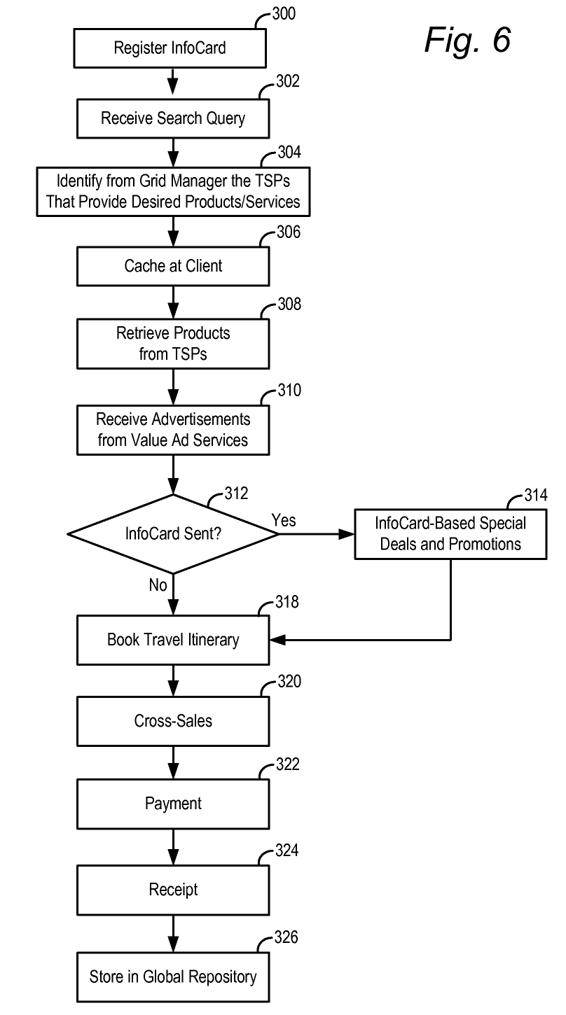

FIG. 6 is a flowchart of an exemplary process which may be carried out by smart client 122 on any of the travel consumer computing devices 120. After the software client 122 has been downloaded, copied or otherwise loaded into a memory of computing device 120, the client 122 may optionally generate an InfoCard according to the Windows Card Space framework developed by Microsoft Corp., Redmond, Wash. The client 122 may register the InfoCard with the grid manager 160 in a step 300. Next, the client may receive a search query or directive via a user interface (explained hereinafter) in step 302. The user interface may allow the user to enter any of a variety of travel-related search queries.

Upon receipt of a search query or directive, the smart client 122 contacts the grid manager 160 in step 304 to identify travel service providers with products or services fulfilling the query. Results retrieved may be cached within the smart client 122 in step 306. Next, the smart client 122 contacts the travel service providers identified by the grid manager 160, and retrieves the products or services which fulfill the query in step 308. Step 308 may be performed by crawler 202 crawling the various travel service providers identified by the grid manager to determine which products or services the identified TSPs have that meet the search requirements. Upon receipt of the search query, in addition to searching travel service providers for products and services fulfilling the search, the smart client may also contact the ad-word server(s) 140 of the value-add service providers. In step 310, the ad-word servers may return advertisements relevant to the words entered in the search query. These advertisements may be displayed to the travel consumer on the graphical user interface.

In step 312, where the traveler has registered an InfoCard, the client 122 may also receive, from one or more travel service providers, special deals and promotions (step 314) by virtue of the travel consumer's status. This status may be looked up or otherwise determined based on the identity established by his or her InfoCard.

After step 314 (or step 312 if the travel consumer does not have an InfoCard), the client 122 may book the travel itinerary selected by the user from the returned search results in step 318. Booking the itinerary may include the step of the client 122 contacting the selected travel service provider, confirming that the travel itinerary is still available and, if so, the travel itinerary may be held by the travel service provider pending the conclusion of the transaction. In embodiments, the itinerary may not be held in step 318, and may only be held upon actually purchasing the itinerary.

In step 320, the client 122 and/or the travel service providers may cross-sell additional products and services to the travel consumer. For example, the travel service provider may offer a discount to the services of another travel service provider based on the selected travel itinerary. Additionally, the smart client 122 may offer a discount to the services of another travel service provider based on the information stored in the travel consumer's personal profile or favorites file on the computing device 120. Further still, the travel service provider and/or the smart client may offer a discount to the services of another travel service provider based on the information associated with the user's InfoCard. A travel consumer may then avail themselves of the discount by contacting the discounting travel service provider and obtaining the cross-sold product or service.

In step 322, the client manages the payment process for the selected inventory. This may entail prompting the travel consumer for credit card information or a variety of other forms of payment. The credit card information might be contained in an InfoCard already provided by the travel consumer, or the travel consumer's client might be asked to provide another InfoCard issued or not issued by a credit card company or other financial institution. In some embodiments, the travel service provider may not be set up for on-line payments. In this instance, the travel service provider may use the grid manager 160 as its agent for payment as described above. In addition to controlling the transfer of funds from the travel consumer's account to the travel service provider or, alternatively, the grid manager 160, step 324 may include a variety of other accounting and financial report generating steps.

In step 326, the client 122 may generate or receive a receipt for the itinerary, payment and/or preferences for the purchased products or services. This receipt may be stored on the consumer's computing device 120. In addition to storing the itinerary on the computing device 120, client 122 may optionally store the itinerary in a global repository that is part of the value-added services. In this instance, the Travel Consumer may view the itinerary from any networked computing device.

In embodiments, communications between travel content hubs 110, travel consumer computing devices 130, value-add servers 140 and grid manager 160 take place over the Internet using standard TCP/IP protocols. Other IP protocols are contemplated. In embodiments, in order to facilitate secure transactions, communications may be carried out using Windows Communication Foundation application programming interface from Microsoft Corp., Redmond, Wash. It is understood that other communications interfaces may be used in alternative embodiments.

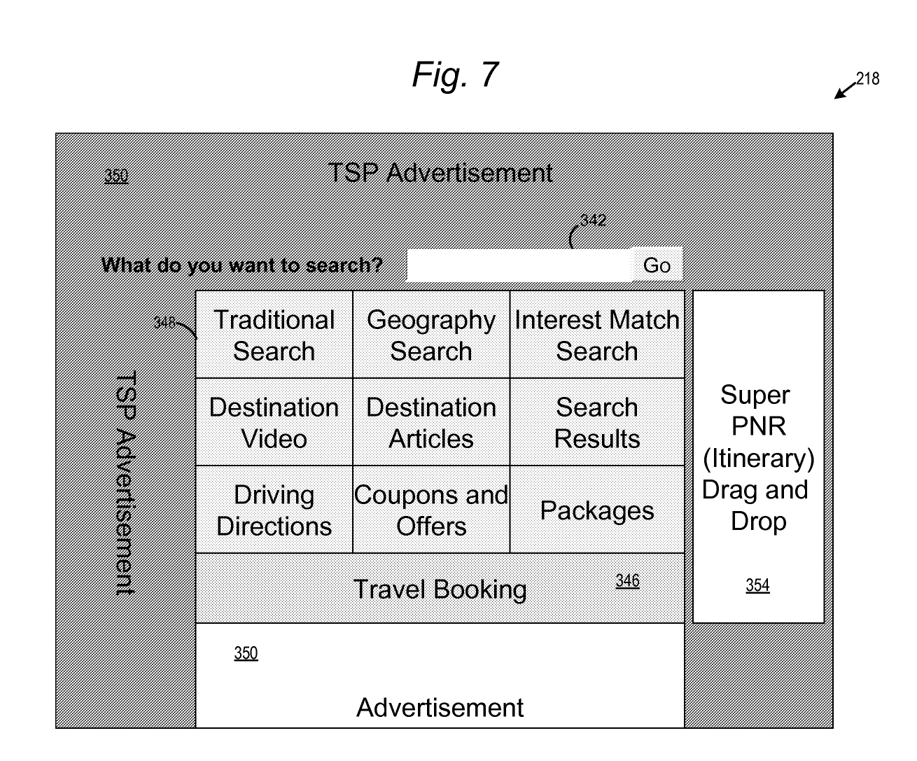

Those of skill in the art will appreciate various known configurations for the user interface 218 for the user to provide information to the smart client 122. FIG. 7 is an illustration of a sample graphical user interface 218 which may be presented to travel consumers by the smart client 122. User interface may work according to XML, but other markup languages may be used in alternative embodiments. As shown, the user interface 218 may include a query entry box 342 for a user to enter the terms that he or she would like to search. The user interface 218 may further include a variety of hyper-linked text boxes for performing different searches when accessed by a mouse or other graphical pointer. For example, user interface 218 may include a “travel booking” text box 346 for retrieving information specifically relating to booking travel. User interface 218 may further include text boxes 348 including a variety of selectable topics for indicating information the user would like to retrieve.

As indicated above, the value-add service providers 140 may return advertisements based upon the search query entered by the user in search query box 342. Those advertisements may be displayed in areas 350 along the top, side and/or bottom of the user interface. Graphical user interface 218 may additionally include a hyper-linked text box 354 for storing a super passenger name record (“PNR”) within value-add trip repository server 140. As discussed above, the repository server 140 may be set up for storing trip itineraries, and may be accessed from any network computing device. A user may designate an itinerary for storage on the global trip repository by dragging and dropping the itinerary within box 354.

Those who are skilled in the art will appreciate a wide variety of other options and layouts for user interface 218 particularly on the variety of device types that may participate in the grid. In a further embodiment, the grid manager 160 may customize user interface 218 with the look and feel of the grid manager's own website. In this way, the grid manager 160 may further enhance brand loyalty and familiarity with the grid manager. Moreover, the user experience might also look nothing like a traditional travel client, but it instead might be done on a map or destination, or for example on a diagram of a cruise ship

In embodiments described above, the grid architecture may include travel service providers, travel consumers, a grid manager, travel service brokers and value-added services. In further embodiments, the grid manager, the travel service brokers and/or the value-added services may be omitted from the grid architecture. In an embodiment where the grid architecture comprises just the travel service providers and the travel consumers, smart client 122 may employ a search engine (either part of inquiry engines 200 or 202, FIG. 3, or separate from those engines) capable of retrieving and, in embodiments, caching, the products and services of travel service providers. Thus, for example, the search engine could identify which airlines travel to specific destinations.

FIG. 8 illustrates an example of a suitable general computing system environment 400 for implementing a smart client as described above. It is understood that the term “computer” as used herein broadly applies to any digital or computing device or system. The computing system environment 400 is only one example of a suitable computing environment and is not intended to suggest any limitation as to the scope of use or functionality of the inventive system. Neither should the computing system environment 400 be interpreted as having any dependency or requirement relating to any one or combination of components illustrated in the exemplary computing system environment 400.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

The present system provides several advantages not found in conventional centralized GDS-based systems. First, the amount of infrastructure required to operate the grid architecture is greatly reduced. Mainframes costing hundreds of millions of dollars each year may be eliminated and the cost saving passed on to the various participants in the grid architecture. Moreover, the grid architecture of the present system makes the products and services of smaller travel service providers much more readily accessible to travel consumers. Further still, the search for products and services is not performed using a web-browser, which presents results in human-readable form from which a human makes travel selections. Instead, the client application program 122 is able to provide a computerized search for, and selection of, applicable products and services. This type of interface is quicker and more powerful that a web-browser search.

With reference to FIG. 8, an exemplary system for implementing the inventive system includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 may include a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes volatile and nonvolatile, as well as removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 430 includes computer storage media in the form of volatile and/or nonvolatile memory such as ROM 431 and RAM 432. A basic input/output system (BIOS) 433, containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 8 illustrates operating system 434, application programs 435, other program modules 436, and program data 437.

The computer 410 may also include other removable/non-removable, volatile/nonvolatile computer storage media. By way of example only, FIG. 8 illustrates a hard disc drive 441 that reads from or writes to non-removable, nonvolatile magnetic media and a magnetic disc drive 451 that reads from or writes to a removable, nonvolatile magnetic disc 452. Computer 410 may further include an optical media reading device 455 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 441 is typically connected to the system bus 421 through a non-removable memory interface such as interface 440. Magnetic disc drive 451 and optical media reading device 455 are typically connected to the system bus 421 by a removable memory interface, such as interface 450.

The drives and their associated computer storage media discussed above and illustrated in FIG. 8, provide storage of computer readable instructions, data structures, program modules and other data for the computer 410. In FIG. 8, for example, hard disc drive 441 is illustrated as storing operating system 444, application programs 445, other program modules 446, and program data 447. These components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and a pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 8. The logical connections depicted in FIG. 8 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communication over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 8 illustrates remote application programs 485 as residing on memory device 481. It will be appreciated that the network connections shown are exemplary and other means of establishing a communication link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A network architecture, comprising:
a plurality of travel service providers;
a client application capable of running on a computing device of a travel consumer, the client application program capable of interacting directly with the plurality of travel service providers to return an aggregate of products and services from the plurality of travel service providers, and to allow the travel consumer to purchase products and/or services from one or more of the plurality of travel service providers.

2. A network architecture as recited in claim 1, the client application program further capable of receiving filtering criteria and filtering the products and services received from the plurality of travel service providers according to the filtering criteria.

3. A network architecture as recited in claim 1, the client application program further capable of receiving sorting criteria and sorting the products and services received from the plurality of travel service providers according to the sorting criteria.

4. A network architecture as recited in claim 1, the client application program further including a rules engine for filtering travel-related products or services according to rules established by the travel consumer or other entity.

5. A network architecture as recited in claim 1, further comprising a network manager for storing an index of the plurality of travel service providers and the products and services they provide.

6. A network architecture as recited in claim 1, further comprising a server, accessible from a plurality of different computing devices, for storing an itinerary of the products and/or services purchased by the travel consumer.

7. A network architecture as recited in claim 1, further comprising a server for storing information relating to advertisements, the server returning an advertisement to the computing device of the travel consumer based on the products and/or services indicated by the travel consumer to be of interest to the travel consumer.

8. A network architecture as recited in claim 1, further comprising a promotion, forwarded by one or more of the plurality of travel service providers to the travel consumer, based on an InfoCard issued to the travel consumer.

9. A network architecture as recited in claim 1, wherein network communications are carried out using a Windows Communication Foundation application programming interface.

10. A network architecture, comprising:
a plurality of travel service providers;
a network manager storing an index of products and/or services of specified travel service providers; and
client application programs, resident on a plurality of computing devices of a plurality of travel consumers, for: 1) identifying travel service providers that provide products and/or services of interest to the travel consumers from a search of the index stored by the network manager, and 2) retrieving a listing of the products and/or services of interest to the travel consumers from the identified travel service providers.

11. A network architecture as recited in claim 10, the client application program further capable of receiving filtering criteria and filtering the products and services received from the plurality of travel service providers according to the filtering criteria.

12. A network architecture as recited in claim 10, the client application program further including a rules engine for filtering travel-related products or services according to rules established by the travel consumer or other entity.

13. A network architecture as recited in claim 10, further comprising a server, accessible from a plurality of different computing devices, for storing an itinerary of the products and/or services purchased by the travel consumer.

14. A network architecture as recited in claim 10, further comprising a server for storing information relating to joint pricing arrangements between two or more travel service providers, information relating to joint pricing arrangement being forwarded to the client application program based on the products and/or services of interest to the travel consumer.

15. A network architecture as recited in claim 10, further comprising a promotion, forwarded by one or more of the plurality of travel service providers to the travel consumer, based on an InfoCard issued to the travel consumer.

16. A computer implemented method of identifying travel-related services comprising the steps of:
(a) establishing a network of travel service providers and travel consumers networked to each other by the Internet; and
(b) enabling software to be added to a plurality of computing devices of a plurality of travel consumers, the software capable of searching the products and services of the plurality of travel service providers to identify products and/or services indicated by the travel consumers to be of interest to the travel consumers.

17. A computer implemented method as recited in claim 16, further comprising the step (c) of enabling software to be added to a plurality of computing devices of a plurality of travel consumers, the software capable of purchasing the products and/or services of the plurality of travel service providers.

18. A computer implemented method as recited in claim 16, further comprising the step (d) of storing an index of products and/or services offered by travel service providers.

19. A computer implemented method as recited in claim 16, further comprising the step (e) of storing an account of financial transactions between a travel service provider and a travel consumer.

20. A computer implemented method as recited in claim 16, further comprising the step (f) of enabling a system where a discount is offered to a travel consumer from the travel service provider.
